(19) United States
(12) Patent Application Publication
(10) Pub. No.: US 2014/0224031 A1
(43) Pub. Date: Aug. 14, 2014

(54) METHOD AND ARRANGEMENT FOR MONITORING GEARWHEELS DURING OPERATION

(71) Applicants: Carl Udo Maier, Stuttgart (DE); Jochen Ostermaier, Erlangen (DE)

(72) Inventors: Carl Udo Maier, Stuttgart (DE); Jochen Ostermaier, Erlangen (DE)

(73) Assignee: Siemens Aktiengesellschaft, München (DE)

(21) Appl. No.: 14/348,400

(22) PCT Filed: Sep. 5, 2012
(86) PCT No.: PCT/EP2012/067318

§ 371 Date: Mar. 28, 2014

(30) Foreign Application Priority Data
Sep. 30, 2011 (DE) 102011083858.9

(51) Int. Cl. G01M 13/02; G01L 1/12

(52) U.S. Cl. CPC G01M 13/021; G01L 1/12
USPC 73/779

(57) ABSTRACT

In a method for monitoring gearwheels during operation using at least one magneto-elastic sensor, which measures without making contact, changes in permeability when mechanical stresses are present in the gearwheel are recorded, wherein the positioning of the at least one magneto-elastic sensor (1) on the gearwheel to be monitored is such that said sensor measures the gearwheel in the region where high stresses occur and forces can be determined by measuring changes in permeability. The method can be used for contactless determination of data on gearwheels.

The invention relates to the monitoring of gearwheels, the stressing of which during operation can be very high, and in the event of damage it is necessary to replace the gearwheel or an entire system.

Previously it has only been possible to deal with the problem of avoiding breakage of a gearwheel by way of indirect methods. Firstly, the length of a maintenance interval can be reduced and the corresponding critical components can be replaced if wear is suspected. Secondly, monitoring of the drive current can be established to determine overstresses, in particular during operation. Both methods are associated with drawbacks, however.

The first method is associated with high costs since, firstly, on the hardware side, components have to be replaced and, secondly, stoppage times cause lower productivity.

The second method is very inaccurate as a whole.

The invention is based on the object of providing a method and a device for contactlessly monitoring gearwheels during operation.

The object is achieved in each case by the combination of features of an independently worded claim.

The invention is based on the knowledge that it is possible to monitor for imminent failure of a gearwheel or the entire gearwheel system by way of the non-destructive measurement of the mechanical stresses on a gearwheel during operation. This occurs by the use of a magneto-elastic sensor which is positioned on a gearwheel to be monitored primarily on the end face and in particular where the greatest mechanical stresses occur. This means that the magneto-elastic sensor is, as a rule, oriented parallel to the axis of the gearwheel and has a slight spacing from the surface of the gearwheel. As a rule, regions of a gearwheel in which the greatest mechanical stresses occur are monitored.

A magneto-elastic sensor measures the permeability during the occurrence of mechanical stresses in the ferromagnetic workpiece. These mechanical stresses change as the stress on the gearwheel changes. If such a gearwheel is overstressed then this can be established by the magneto-elastic sensor and the gearwheel or a gearwheel system can be switched off in good time before a breakage.

It is particularly advantageous if this method is combined with a frequency analysis. The tooth engagement frequencies by way of example can be calculated thereby. Additional information, by way of example about a state of a gear, can therefore be obtained.

If an additional magneto-elastic sensor is used then further forces may also be directly measured. This necessitates that the orientation of the main sensitivity of the additional magneto-sensor is changed relative to the at least one sensor. The adjustment can be made by moving the sensor head of the additional magneto-elastic sensor.

To improve the spatial resolution of the force distribution it is advantageous to use a magneto-elastic sensor array. This may firstly be implemented in the form of a presentation of a one-dimensionally resolving line sensor.

A plurality of magneto-elastic sensors is arranged one behind the other in a line in this sensor.

A two-dimensional, i.e. planar, sensor array has a large number of magneto-elastic sensors which span an area.

It is particularly advantageous to use monitoring for quality control of gearwheels as well. Gearwheels are monitored during simulated operation, so the mechanical stresses correspond roughly with reality. Operation is simulated in this case, however.

Static or dynamic states can therefore be monitored in real operation as well as simulated operation. The loading capacity or stress of one or more gearwheel(s) can be investigated very accurately using the method.

The rotational speed and the instantaneous angular position of the gearwheel due to the mechanical stresses in the component may also be determined in a time-resolved manner using the same method.

If the positioning of the magneto-elastic sensor is carried out frontally or laterally in the vicinity of the teeth of a gearwheel, then the profile of the gearwheel can be discerned. Deviations in the geometry can advantageously be established from this. Monitoring for wear or damage can in turn be carried out therefore.

The execution of a method in accordance with the invention can advantageously take place by way of a sensor arrangement which is capable of detecting stresses on a gearwheel. This occurs with the use of one or more magneto-elastic sensors which can non-destructively record the mechanical stresses on one or more gearwheel(s) during operation, by way of example in the region of reciprocal engagement.

An exemplary embodiment which does not restrict the invention will be described below with reference to the schematic figures, in which:

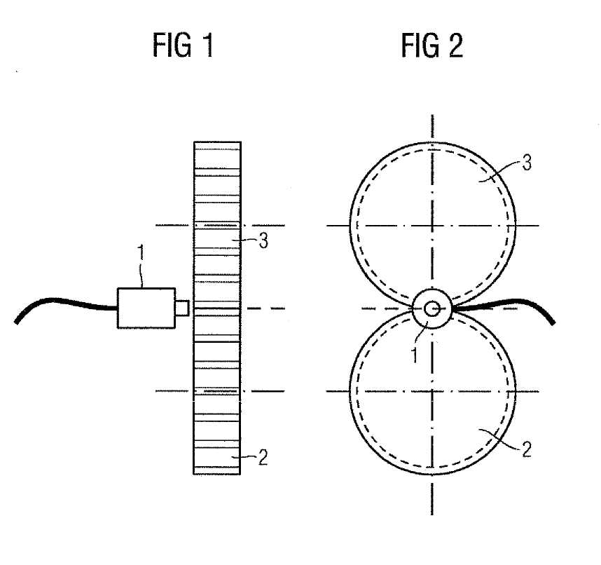

FIG. 1 shows gearwheel monitoring using a magneto-elastic sensor 1 which operates without contact and which is oriented toward a gearwheel 3 to be monitored, and a gearwheel 2 engaged with gearwheel 3,

FIG. 2 shows a view corresponding to FIG. 1 which is rotated about 90°.

A magneto-elastic sensor 1 is based on the effect of the magnetic change in permeability with a change in length. The magnetic properties of a material are influenced by mechanical forces that occur and act on the material.

The corresponding sensors are distinguished by high measuring accuracy and measure a force directly. A sensor of this kind is positioned without contact at a certain distance from the object to be measured and can be used during operation. Torques, by way of example, on shafts which transmit forces can therefore be measured in that changes in the permeabilities of a shaft are contactlessly measured by means of a magneto-elastic sensor.

According to the invention non-destructive monitoring of gearwheels is enabled, which gearwheels are subjected to mechanical stresses due to forces that act from the outside. Stresses on gearwheels are measured during operation in this connection. If quality assurance is to be carried out before use of a component then operation may also be simulated, wherein as far as possible states similar to operation are created. Therefore a gearwheel by way of example is brought into engagement with a further gearwheel and a gearwheel that is to be checked is stressed as during operation. The stress during simulated operation is measured by a magneto-elastic sensor, so the forces in the gearwheel to be monitored are recorded and for example specific desired values of mechanical stress are started.

It is thereby possible to prevent breakage or destruction of machines by adjusting the operation of these components or systems in good time. Overall, maintenance intervals in particular can be extended. Components which are not yet worn during regular inspections are therefore not replaced. The lifetimes of systems can be extended therefore.

If a component does not have a ferromagnetic construction per se, a ferromagnetic layer by way of example can be, at least partially, applied to the surface. Coupling of a magneto-elastic sensor to measure forces that occur in a component with a high level of accuracy is therefore possible.

FIG. 1 shows two reciprocally engaging gearwheels 2, 3 in side view, so the teeth can be seen from the outside. The magneto-elastic sensor 1 is positioned offset to the axis of rotation of the gearwheel 3 to be monitored, in the vicinity of the end face or in the region of high stressing of the gearwheel and at a distance from the surface of the gearwheel.

FIG. 2 shows a view which is rotated by 90° relative to the depiction in FIG. 1. The two gearwheels 2, 3 can now be seen at the end face and the depiction of the respective teeth of the gearwheels is illustrated solely by depiction of the respective divided circles of the gearwheels.

The exact positioning of the magneto-elastic sensor 1 is adjusted according to the corresponding requirements. In FIG. 2 the magneto-elastic sensor 1 is oriented more or less toward the roots of the gearwheels of the gearwheel 3 to be monitored. Forces in the region of a gearwheel which, as a rule, is highly stressed, can therefore be recorded. A comparison with desired values can also be made, so predetermined maximum stresses cease or the mode of operation is changed accordingly.

1-10. (canceled)

11. A method for quality assurance of a gearwheel, comprising:
prior to use of the gearwheel, engaging the gearwheel with another gearwheel in a simulated operation and applying in the simulated operation a stress to the gearwheel as in an actual operation,
measuring with at least one magneto-elastic sensor, without contact between the at least one magneto-elastic sensor and the gearwheel, the stress in the simulated operation for recording changes in permeability caused by a mechanical stress present in the gearwheel,
approaching specific desired values of mechanical stress, wherein the at least one magneto-elastic sensor is positioned on the gearwheel such that the at least one magneto-elastic sensor senses the gearwheel in the region where high levels of stress occur and determines forces by measuring changes in the permeability, and
comparing the determined forces with desired force values, wherein the at least one magneto-elastic sensor is further positioned with respect to the gearwheel so as to determine deviations from a desired geometry.

12. The method as claimed in claim 11, further performing a frequency analysis.

13. The method of claim 11, wherein the at least one magneto-elastic sensor comprises a sensor array having a plurality of sequentially arranged magneto-elastic sensors.

14. The method of claim 13, wherein the sensor array is a two-dimensional sensor array.

15. The method of claim 11, further comprising measuring a parameter selected from a rotational speed, an instantaneous angular position, and a time-resolved mechanical stress.

16. The method of claim 11, wherein the at least one magneto-elastic sensor is positioned with respect to the gearwheel such that the gearwheel is represented in profile.

17. A sensor arrangement for detecting stress on at least one gearwheel in a simulated operation, the sensor arrangement comprising a sensor array having a plurality of sequentially arranged magneto-elastic sensors oriented toward the at least one gearwheel, wherein the sensor arrangement is configured to measure, without contact between the at least one magneto-elastic sensor and the gearwheel, changes in permeability in the at least one gearwheel when a mechanical stress is present in the at least one gearwheel, to determine forces from the measured changes in the permeability, to compare the determined forces with desired force values, to determine deviations from a desired geometry of the at least one gearwheel, and to visualize the determined forces.

18. The sensor arrangement of claim 17, wherein the sensor arrangement is a two-dimensional sensor array oriented toward the at least one gearwheel.
